(19) United States
(12) Patent Application Publication
(10) Pub. No.: US 2008/0145635 A1
(43) Pub. Date: Jun. 19, 2008

(54) Automotive interior structural components with integral close-out panel

(75) Inventors: Steven Stoll, Macomb, MI (US); Amy Conover, Lake Orion, MI (US)

Correspondence Address: JOHN S. BEULICK (19121), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/639,949

(22) Filed: Dec. 15, 2006

(51) Int. Cl. B32B 7/08; B29C 43/32

(52) U.S. Cl. 428/223; 264/238

(57) ABSTRACT

A method of making an automotive vehicle interior structural component having a decorative close-out panel includes, in an exemplary embodiment, positioning a thermoplastic material sheet in a forming tool, the thermoplastic material sheet includes a thermoplastic resin, positioning a decorative material sheet in the forming tool adjacent to the thermoplastic sheet, attaching the decorative material to the thermoplastic material with an integral hinge, and forming the structural component by applying at least one of heat and pressure to the forming tool.

### BACKGROUND OF THE INVENTION

This invention relates generally to lightweight automotive vehicle interior structural components, and more particularly to lightweight automotive vehicle interior structural components formed from thermoformable thermoplastic materials and having an integral decorative close-out panel.

Tougher automotive fuel economy standards are requiring an overall vehicle weight reduction to meet these standards. For example, traditional vehicle seat back systems are made from stamped steel or blow molded plastics. Steel stamping dies are a huge capital investment. Although a steel seat back is thin, the steel material is very dense compared with polymers. Steel seat back can range from about 3 lbs to 6 lbs. The steel seat back is spot welded to the seat frame and structural reinforcements are attached to the corners of the steel seat back to prevent and bending of the steel when a load is applied. Blow molded seat backs are lighter than steel seat backs, but are bulky and can be 50 mm or greater in thickness. Blow molded plastic seat backs are attached mechanically to the seat frame.

Also, multiple components are typically used to make a seat back panel. For example, the structural seat back panel for second and third row seats in a multi-purpose vehicle is combined with an decorative close-out panel to provide a pleasing outer surface visible to the occupant. However, the multiple components and attachment mechanisms add complexity and cost to the seat. Also, because of multiple components there can be a problem with stack-up tolerances, fit, and production inefficiencies.

### BRIEF DESCRIPTION OF THE INVENTION

In one aspect, a method of making an automotive vehicle interior structural component having a decorative close-out panel is provided. The method includes positioning a thermoplastic material sheet in a forming tool, the thermoplastic material sheet includes a thermoplastic resin, positioning a decorative material sheet in the forming tool adjacent to the thermoplastic sheet, attaching the decorative material to the thermoplastic material with an integral hinge, and forming the structural component by applying at least one of heat and pressure to the forming tool.

In another aspect, an automotive vehicle interior structural component is provided. The automotive vehicle interior structural component includes a structural member formed from a thermoplastic material, and a decorative close-out panel attached to the structural member with an integral hinge.

### BRIEF DESCRIPTION OF THE DRAWINGS

FIG. 1 is a perspective schematic illustration of an automobile seat that includes a structural seat back component in accordance with an embodiment of the present invention.

FIG. 2 is a rear view schematic illustration of the structural seat back component having an integral close-out panel.

FIG. 3 is a cross sectional schematic illustration through line A-A of the structural seatback component shown in FIG. 2.

### DETAILED DESCRIPTION OF THE INVENTION

An automobile structural seat back component having an integral decorative close-out panel and a method of making the structural seat back component is described in detail below. Although the exemplary embodiment described below is an automobile structural seat back component, other exemplary embodiments can include other vehicle structural components, for example, vehicle door modules, interior cargo management systems, and the like. The structural seat back component is formed using materials with differing physical properties and aesthetic (decorative) characteristics to provide various properties in different locations of the structural component. By manufacturing a component that has both decorative and structural properties, and an integral hinge, the dimensional tolerances of the component portions are reduced. When the structural and decorative portions are manufactured as separate articles, there are both stack-up tolerances from the articles being combined as well as production and cost inefficiencies.

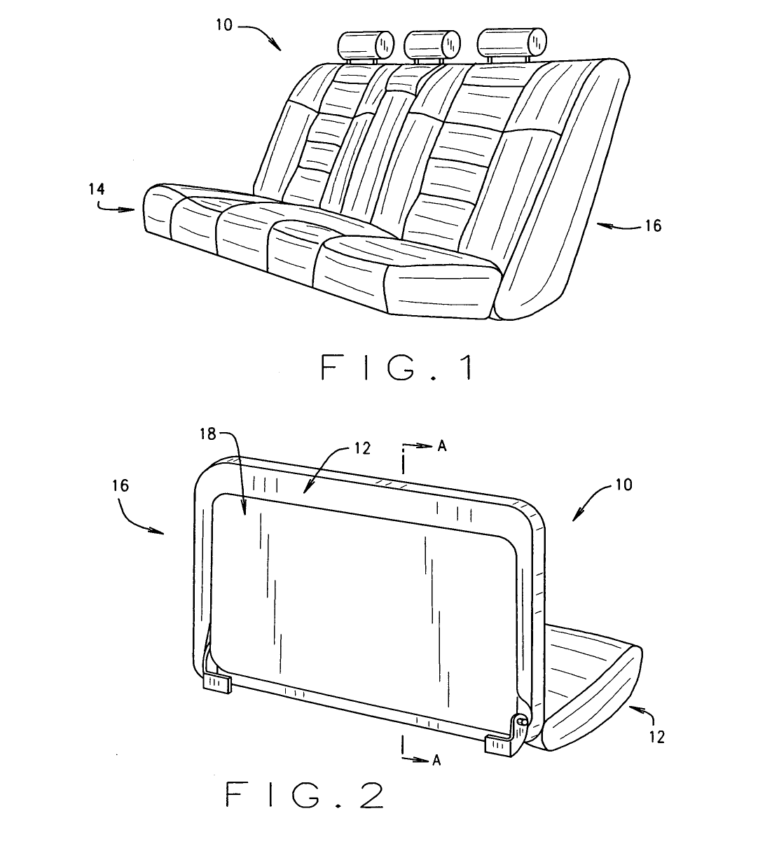

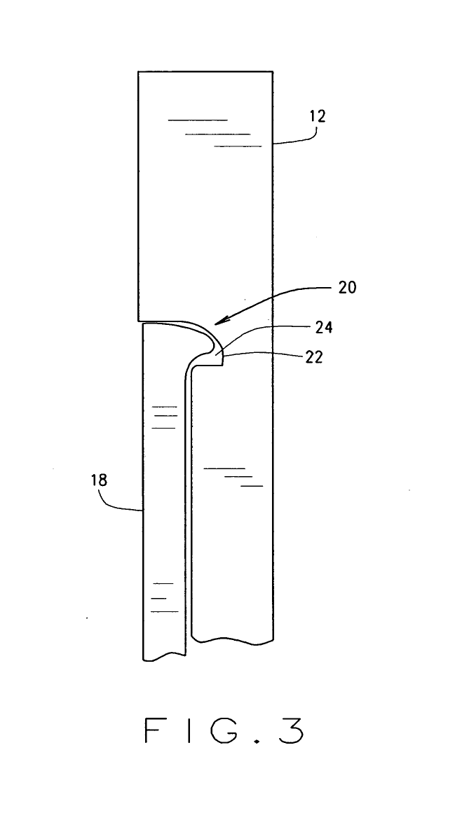

Referring to the drawings, FIG. 1 is a perspective schematic illustration of an automobile vehicle seat 10 and FIG. 2 is a rear view schematic illustration of a structural seat back component 12. Referring to FIGS. 1 and 2, automobile vehicle seat 10 includes a seat portion 14 and a seat back portion 16. In the exemplary embodiment seat 10 is a rear bench seat that can be used, for example, in sedans, coupes, SUVs, and small trucks. Seat back portion 16 includes structural seat back component 12 which includes a decorative close-out panel 18 to provide an aesthetic appearance by covering the inner attachment and structural support members of structural seat back component 12.

Referring also to FIG. 3, decorative close-out panel 18 is coupled to structural seat back component 12 by an integral hinge 20. Integral hinge 20 can be any suitable type of hinge, for example, a mechanical hinge, a rubber hinge, and/or a flexible thermoplastic material hinge. Suitable flexible thermoplastic materials include, but are not limited to, thermoplastic elastomers, thermoplastic urethanes, silicones, polypropylene, polyethylene, polycarbonates, and mixtures thereof. In the exemplary embodiment integral hinge 20 includes a recess portion 22 in structural seat back component 12 and a rubber or flexible thermoplastic material 24 coupling decorative close-out panel 18 to structural seat back component 12. Integral hinge 20 permits decorative close-out panel 18 to be rotated along hinge 20 to give access to interior portions of structural seat back component 12 without completely detaching decorative closeout panel 18 from structural seat back component 12.

Structural seat back component 12 is formed from any suitable thermoplastic resin, including, but not limited to, polyolefins, polyamides, polystyrene, acrylonitrylstyrene, butadiene, polyesters, polybutyleneterachlorate, polyvinyl chloride, polyphenylene ether, polyphenylene oxide, polyether imide, polycarbonates, polyestercarbonates, acrylonitrile-butylacrylate-styrene polymers, polybutyleneterephthalate, polyethyleneteraphthalate, amorphous nylon, and mixtures thereof. In one embodiment, structural seat back component 12 also includes a plurality of reinforcing fibers bonded together by the thermoplastic resin. Suitable reinforcing fibers include, but are not limited to metal fibers, metalized inorganic fibers, metalized synthetic fibers, glass fibers, polyester fibers, polyamide fibers, graphite fibers, carbon fibers, ceramic fibers, mineral fibers, basalt fibers, inorganic fibers, aramid fibers, kenaf fibers, jute fibers, flax fibers, hemp fibers, cellulosic fibers, sisal fibers, coir fibers, and mixtures thereof.

In another exemplary embodiment, structural seat back component 12 is formed from a permeable fiber reinforced thermoplastic sheet that has a core layer that includes from about 20 weight percent to about 80 weight percent of reinforcing fibers bonded together by a thermoplastic resin. The core layer has a density of about 0.1 grams (gm)/cubic centimeter (cc) to about 1.8 gm/cc and a void content of about 5 percent to about 95 percent. The permeable core layer, in alternate embodiments, can include one or more reinforcing skins bonded to one or both sides of the core layer. Permeable fiber reinforcing thermoplastic sheets, with or without reinforcing skins are commercially available from Azdel, Inc., Shelby, N.C., under the trademark SUPERLITE®.

The permeable core is formed from a web made up of open cell structures formed by random crossing over of reinforcing fibers held together, at least in part, by one or more thermoplastic resins, where the void content of the permeable core ranges in general between about 1% and about 95% and in particular between about 30% and about 80% of the total volume of core 12. In another embodiment, the permeable core is made up of open cell structures formed by random crossing over of reinforcing fibers held together, at least in part, by one or more thermoplastic resins, where about 40% to about 100% of the cell structure are open and allow the flow of air and gases through. The permeable core has a density in one embodiment of about 0.1 gm/cc to about 1.8 gm/cc and in another embodiment about 0.3 gm/cc to about 1.0 gm/cc. The permeable core is formed using known manufacturing process, for example, a wet laid process, an air laid process, a dry blend process, a carding and needle process, and other known process that are employed for making non-woven products. Combinations of such manufacturing processes are also useful.

The permeable core includes about 20% to about 80% by weight of reinforcing fibers having an average length of between about 5 mm and about 50 mm, and about 20% to about 80% by weight of a wholly or substantially unconsolidated fibrous or particulate thermoplastic materials, where the weight percentages are based on the total weight of the permeable core In another embodiment, the permeable core includes about 30% to about 55% by weight of reinforcing fibers. In another embodiment, the core includes reinforcing fibers having an average length of between about 5 mm and about 25 mm.

In the exemplary embodiment, reinforcing fibers are added with thermoplastic powder particles, for example polypropylene powder, to an agitated aqueous foam which can contain a surfactant. The components are agitated for a sufficient time to form a dispersed mixture of the reinforcing fibers and thermoplastic powder in the aqueous foam. The dispersed mixture is then laid down on any suitable support structure, for example, a wire mesh, and then the water is evacuated through the support structure forming a web. The web is dried and heated above the softening temperature of the thermoplastic powder. The web is then cooled and pressed to a predetermined thickness to produce composite the permeable core having a void content of between about 5 percent to about 95 percent.

Decorative close-out panel 18, in one embodiment, is formed from a thermoplastic film of, for example, polyvinyl chloride, polyolefin, thermoplastic polyester, thermoplastic elastomer, or the like. In another embodiment, decorative close-out panel 18 is a multilayered structure that includes a foam core formed from, for example, polypropylene, polyethylene, polyvinyl chloride, polyurethane, and the like. A fabric is bonded to the foam core, for example, woven fabrics made from natural and synthetic fibers, organic fiber nonwoven fabric after needle punching or the like, raised fabric, knitted goods, flocked fabric and the like. In another embodiment the fabric is bonded to the foam core with a thermoplastic adhesive, including pressure sensitive adhesives and hot melt adhesives, for example, polyamides, modified polyolefins, urethanes and polyolefins. In one exemplary embodiment, decorative close-out panel 18 is formed from carpeting.

In one embodiment, structural seat back component 12, with integral decorative close-out panel 18, are formed with the use of thermoforming equipment, where either cut blanks, or continuous roll stock of structural thermoplastic materials and decorative materials are combined within different sections of the thermoforming tool. The materials are combined together using heat with or without selective pressure to create a finished structural seat back component 12, with integral decorative close-out panel 18. This forming method can also involve the use of a matched tool. Both the decorative and structural materials are preheated and then placed into the tool. Using low pressures, less than about 50 psi, the materials are formed with integral hinge 20 in between the two sheets.

In another embodiment, a single sided tool, either male or female combined with a pressure box, and if necessary, plug assist is used to form structural seat back component 12, with integral decorative close-out panel 18. Attachment mechanisms, including integral hinge 20 are pre-placed into the tool and the structural thermoplastic material is molded behind. Carpets, fabrics and films are also placed into the tool to be molded over the decorative portion of the close out panel or the structural portion as desired. If necessary a heat activated adhesive is place on one or more of the structural seat back component 12 or decorative close-out panel 18 to facilitate bonding. Very fast cycle times, 60 seconds or less, can be achieved using this process. Thermoforming employs low investment tooling with quick prototype capabilities. Low cost tooling can be fabricated from composites, aluminum, and the like.

In another embodiment, low-pressure injection or injection/compression molding are used to form structural seat back component 12, with integral decorative close-out panel 18. Pre-cut decorative sections (carpeting, fabric, films, etc.) along with selective reinforcement sheets, the whole or part of which are then overmolded with thermoplastic material to lock the various components together. Integral hinge(s) 20 are also molded into structural seat back component 12, with integral decorative close-out panel 18, along with undercuts such as attachment “doghouses” that are molded in through the use of lifters and/or slides in the injection and/or injection/compression molding tooling. This method uses matched mold tooling incorporating both a core and cavity.

While the invention has been described in terms of various specific embodiments, those skilled in the art will recognize that the invention can be practiced with modification within the spirit and scope of the claims.

What is claimed is:

1. A method of making an automotive vehicle interior structural component having a decorative close-out panel, said method comprising:
positioning a thermoplastic material sheet in a forming tool, the thermoplastic material sheet comprising a thermoplastic resin;
positioning a decorative material sheet in the forming tool adjacent to the thermoplastic sheet;
attaching the decorative material to the thermoplastic material with an integral hinge; and
forming the structural component by applying at least one of heat and pressure to the forming tool.

2. A method in accordance with claim 1 wherein the thermoplastic material sheet comprises a plurality of reinforcing fibers bonded together with the thermoplastic resin.

3. A method in accordance with claim 2 wherein the thermoplastic material sheet comprises a permeable thermoplastic material sheet having a density of about 0.1 gm/cc to about 1.8 gm/cc, the permeable thermoplastic sheet formed by a paper making process.

4. A method in accordance with claim 2 wherein the reinforcing fibers comprise at least one of metal fibers, metalized inorganic fibers, metalized synthetic fibers, glass fibers, polyester fibers, polyamide fibers, graphite fibers, carbon fibers, ceramic fibers, mineral fibers, basalt fibers, inorganic fibers, aramid fibers, kenaf fibers, jute fibers, flax fibers, hemp fibers, cellulosic fibers, sisal fibers, and coir fibers.

5. A method in accordance with claim 1 wherein the thermoplastic resin comprises at least one of polyolefins, polyamides, polystyrene, acrylonitrylstyrene, butadiene, polyesters, polybutyleneterachlorate, polyvinyl chloride, polyphenylene ether, polyphenylene oxide, polyether imide, polycarbonates, polyestercarbonates, acrylonitrile-butylacrylate-styrene polymers, polybutyleneterephthalate, polyethyleneteraphthalate, and amorphous nylon.

6. A method in accordance with claim 1 wherein attaching the decorative material to the thermoplastic material with an integral hinge comprises attaching the decorative material to the thermoplastic material with at least one of mechanical hinge, a rubber hinge, and a flexible thermoplastic material hinge.

7. A method in accordance with claim 1 further comprising overmolding the thermoplastic material sheet and the decorative material sheet with a second thermoplastic resin to lock the thermoplastic material sheet and the decorative material sheet together.

8. A method in accordance with claim 7 further comprising molding the integral hinge into the component with the second thermoplastic resin.

9. A method in accordance with claim 1 wherein the thermoplastic material sheet comprises a core layer and at least one reinforcing skin covering at least a portion of at least one outer surface of the core layer.

10. A method in accordance with claim 9 further comprising forming the integral hinge with a portion of the at least one reinforcing skin.

11. An automotive vehicle interior structural component comprising:
a structural member comprising a thermoplastic material; and
a decorative close-out panel attached to said structural member with an integral hinge.

12. An automotive vehicle interior structural component in accordance with claim 11 wherein the thermoplastic material comprises a plurality of reinforcing fibers bonded together with a thermoplastic resin.

13. An automotive vehicle interior structural component in accordance with claim 12 wherein the thermoplastic material comprises a permeable thermoplastic composite having a density of about 0.1 gm/cc to about 1.8 gm/cc, the permeable thermoplastic composite formed by a paper making process.

14. An automotive vehicle interior structural component in accordance with claim 12 wherein the reinforcing fibers comprise at least one of metal fibers, metalized inorganic fibers, metalized synthetic fibers, glass fibers, polyester fibers, polyamide fibers, graphite fibers, carbon fibers, ceramic fibers, mineral fibers, basalt fibers, inorganic fibers, aramid fibers, kenaf fibers, jute fibers, flax fibers, hemp fibers, cellulosic fibers, sisal fibers, and coir fibers.

15. An automotive vehicle interior structural component in accordance with claim 12 wherein the thermoplastic resin comprises at least one of polyolefins, polyamides, polystyrene, acrylonitrylstyrene, butadiene, polyesters, polybutyleneterachlorate, polyvinyl chloride, polyphenylene ether, polyphenylene oxide, polyether imide, polycarbonates, polyestercarbonates, acrylonitrile-butylacrylate-styrene polymers, polybutyleneterephthalate, polyethyleneteraphthalate, and amorphous nylon.

16. An automotive vehicle interior structural component in accordance with claim 11 wherein the integral hinge comprises at least one of a mechanical hinge, a rubber hinge, and a flexible thermoplastic material hinge.

17. An automotive vehicle interior structural component in accordance with claim 11 wherein said thermoplastic material and the decorative material close-out panel are attached with a second thermoplastic resin to lock the thermoplastic material sheet and the decorative material sheet together.

18. An automotive vehicle interior structural component in accordance with claim 17 wherein said integral hinge is formed from said second thermoplastic resin.

19. An automotive vehicle interior structural component in accordance with claim 11 wherein the thermoplastic material composite comprises a core layer and at least one reinforcing skin covering at least a portion of at least one outer surface of the core layer.

20. An automotive vehicle interior structural component in accordance with claim 19 further comprising forming the integral hinge with a portion of the at least one reinforcing skin.
